(19) United States
(12) Patent Application Publication
(10) Pub. No.: US 2010/0321567 A1
(43) Pub. Date: Dec. 23, 2010

(54) VIDEO DATA GENERATION APPARATUS, VIDEO DATA GENERATION SYSTEM, VIDEO DATA GENERATION METHOD, AND COMPUTER PROGRAM PRODUCT

(76) Inventor: Yoshitomo Tanaka, Nagoya (JP)

Correspondence Address: OSTROLENK FABER GERB & SOFFEN, 1180 AVENUE OF THE AMERICAS, NEW YORK, NY, 100368403, US

(21) Appl. No.: 12/817,774

(22) Filed: Jun. 17, 2010

(30) Foreign Application Priority Data
Jun. 19, 2009 (JP) 2009-145999

(51) Int. Cl. H04N 7/01; H04N 9/475

(52) U.S. Cl. 348/441; 348/512; 348/E09.034; 348/E07.003

(57) ABSTRACT

A video data generation apparatus generates video data based on audio data and frame image data, which are generated independently of each other. The video data generation apparatus sequentially inputs the audio data at fixed intervals, while sequentially inputting the frame image data in time series at irregular intervals. Simultaneously with input of one frame of frame image data, the video data generation apparatus starts a data acquisition process to obtain next one frame of frame image data. The video data generation apparatus stores audio data, which have been input in a period between a start of the data acquisition process by the data acquirer and input of one frame of frame image data by the data acquisition process, in combination with the frame image data of one frame obtained by the data acquisition process, as one audio image complex data, and generates the video data based on multiple stored audio image complex data.

### CROSS-REFERENCE TO RELATED APPLICATION

The present application claims priority from Japanese application P2009-145999A filed on Jun. 19, 2009, the content of which is hereby incorporated by reference into this application.

### BACKGROUND

1. Field of the Invention

The present invention relates to a technique of generating video data.

2. Description of the Related Art

There is the known technique of taking a moving image with an imaging apparatus, such as a visual presenter, a digital camera, or a web camera and generating video data based on the image data obtained via the imaging apparatus and audio data obtained via a microphone attached to or externally connected to the imaging apparatus. Reproduction of the generated video data may cause asynchronism or a time lag between the

reproduced image and the reproduced sound. Such asynchronism may be ascribed to failed synchronization of simultaneously-generated audio data and image data in the course of generation of the video data.

One proposed technique for eliminating the asynchronism assigns an absolute time or time stamp to each of the audio data and the image data in an input apparatus of the audio data and the image data or a moving image generation apparatus and synchronizes the audio data and the image data based on the assigned time stamps. This method requires the precise matching of the internal times of the imaging apparatus, the microphone, and the moving image generation apparatus, as well as the stable generation of the image data and the audio data by the moving image generation apparatus and the microphone. When there is any difference between the internal times of the moving image generation apparatus and the microphone, the method should generate video data by observing and taking into account a time difference or an input time lag between a period from generation of the image data to input of the image data into the moving image generation apparatus and a period from generation of the audio data to input of the audio data into the moving image generation apparatus. A proposed technique of storing input data with addition of other information is described in, for example, JP-A-No. 2006-0334436. A proposed technique of comparing multiple data with regard to time-related information is described in, for example, JP-A-No. 2007-059030.

The method of assigning the time stamp to each of the audio data and the image data naturally requires a mechanism of assigning the time stamp in the moving image generation apparatus and moreover needs the precise setting of the internal times of the moving image generation apparatus, the microphone, and the imaging apparatus. The method of generating video data by taking into account the input time lag may still cause asynchronism or a time lag in a system with the varying input time lag.

### SUMMARY

By taking into account the above issue, the present invention accomplishes at least part of the requirement of eliminating asynchronism or a time lag by the following configurations and arrangements.

One aspect of the invention is directed to a video data generation apparatus of generating video data based on audio data and frame image data, which are generated independently of each other. The video data generation apparatus has an audio input configured to sequentially input the audio data at fixed intervals, and an image input configured to sequentially input the frame image data in time series at irregular intervals. The video data generation apparatus also has a data acquirer configured to, simultaneously with input of one frame of frame image data, start a data acquisition process to obtain next one frame of frame image data. The video data generation apparatus further has a storage configured to store audio data, which have been input in a period between a start of the data acquisition process by the data acquirer and input of one frame of frame image data by the data acquisition process, in combination with the frame image data of one frame obtained by the data acquisition process, as one audio image complex data, and a video data converter configured to generate the video data based on multiple audio image complex data stored in the storage.

The video data generation apparatus according to this aspect of the invention generates video data based on audio data and frame data, which are generated independently of each other, without causing asynchronism or a time lag between the audio data and the image data.

In one preferable application of the video data generation apparatus according to the above aspect of the invention, the audio data are input into the video data generation apparatus at shorter cycles than those of the frame image data.

The video data generation apparatus of this application enables video data to be generated without causing asynchronism or a time lag, based on the frame image data and the audio data input at different cycles.

In another preferable application of the video data generation apparatus according to the above aspect of the invention, the audio data are input as data in a preset time unit.

The video data generation apparatus of this application enables video data to be generated without causing asynchronism or a time lag, based on the frame image data and the audio data input in the preset time unit.

In one preferable embodiment of the video data generation apparatus according to the above aspect of the invention, the audio data are generated based on voice and sound collected via a microphone and are input into the video data generation apparatus.

The video data generation apparatus of this embodiment enables video data to be generated without causing asynchronism or a time lag, based on the frame image data and the audio data generated from the voice and sound collected via the microphone.

In another preferable embodiment of the video data generation apparatus according to the above aspect of the invention, the audio data are generated based on sound output from an audio output apparatus having a sound source and are input into the video data generation apparatus.

The video data generation apparatus of this embodiment enables video data to be generated without causing asynchronism or a time lag, based on the frame image data and the audio data generated from the sound output from the audio output apparatus having the sound source, for example, a musical instrument.

In one preferable application of the video data generation apparatus according to the above aspect of the invention, the frame image data are input into the video data generation apparatus from one of a visual presenter, a digital camera, and a web camera.

The video data generation apparatus of this application enables video data to be generated without causing asynchronism or a time lag, based on the audio data and the frame image data obtained from any one of the visual presenter, the digital camera, and the web camera.

In another preferable application of the video data generation apparatus according to the above aspect of the invention, the frame image data are input in a data format selected among the group consisting of a JPG or JPEG data format, a BMP or Bitmap data format, and a GIF data format.

The video data generation apparatus of this application enables video data to be generated without causing asynchronism or a time lag, based on the audio data and the frame image data in any of the JPG data format, the BMP data format, and the GIF data format.

In still another preferable application of the video data generation apparatus according to the above aspect of the invention, the video data are generated in an AVI or audio video interleave data format.

The video data generation apparatus of this application generates the video data in the AVI data format, based on the audio data and the frame image data. The video data in the AVI data format is generable by a simpler conversion process, compared with video data in other data formats, such as an MPG data format.

Another aspect of the invention is directed to a video data generation system including a video data generation apparatus, a visual presenter, and a microphone. The video data generation apparatus has an audio input configured to sequentially input the audio data via the microphone at fixed intervals, and an image input configured to sequentially input the frame image data from the visual presenter in time series at irregular intervals. The video data generation apparatus also has a data acquirer configured to, simultaneously with input of one frame of frame image data, start a data acquisition process to obtain next one frame of frame image data. The video data generation apparatus further has a storage configured to store audio data, which have been input in a period between a start of the data acquisition process by the data acquirer and input of one frame of frame image data by the data acquisition process, in combination with the frame image data of one frame obtained by the data acquisition process, as one audio image complex data, and a video data converter configured to generate the video data based on multiple audio image complex data stored in the storage.

The video data generation system according to this aspect of the invention generates video data based on audio data and frame data, which are generated independently of each other, without causing asynchronism or a time lag between the audio data and the image data.

According to still another aspect, the invention is directed to a video data generation method of generating video data based on audio data and frame image data, which are generated independently of each other. The video data generation method sequentially inputs the audio data at fixed intervals, while sequentially inputting the frame image data in time series at irregular intervals. Simultaneously with input of one frame of frame image data, the video data generation method starts a data acquisition process to obtain next one frame of frame image data. The video data generation method stores audio data, which have been input in a period between a start of the data acquisition process by the data acquirer and input of one frame of frame image data by the data acquisition process, in combination with the frame image data of one frame obtained by the data acquisition process, as one audio image complex data, and generates the video data based on multiple stored audio image complex data.

The video data generation method according to this aspect of the invention generates video data based on audio data and frame data, which are generated independently of each other, without causing asynchronism or a time lag between the audio data and the image data.

Another aspect of the invention is directed to a computer program product including a program of causing a computer to generate video data based on audio data and frame image data, which are generated independently of each other. The computer program recorded on a recordable medium causes the computer to attain the functions of sequentially inputting the audio data at fixed intervals; sequentially inputting the frame image data in time series at irregular intervals; simultaneously with input of one frame of frame image data, starting a data acquisition process to obtain next one frame of frame image data; storing audio data, which have been input in a period between a start of the data acquisition process by the data acquirer and input of one frame of frame image data by the data acquisition process, in combination with the frame image data of one frame obtained by the data acquisition process, as one audio image complex data; and generating the video data based on multiple stored audio image complex data.

The computer program according to this aspect of the invention causes the computer to generate video data based on audio data and frame data, which are generated independently of each other, without causing asynchronism or a time lag between the audio data and the image data.

### BRIEF DESCRIPTION OF THE DRAWINGS

FIG. 1 is a configuration diagrammatic representation of a video imaging system according to one embodiment of the invention;

FIG. 2 is an explanatory diagrammatic representation of the internal structure of a visual presenter included in the video imaging system;

FIG. 3 is an explanatory diagrammatic representation of the structure of a computer included in the video imaging system;

FIG. 4 is flowcharts showing an image output process and a data acquisition process performed in the embodiment;

FIG. 5 is flowcharts showing a data storage process and a video data conversion process performed in the embodiment;

FIG. 6 is an explanatory diagrammatic representation the concept of the data acquisition process, the data storage process, and the video data conversion process; and

FIG. 7 is an explanatory diagrammatic representation of the concept of reproduction of video data.

### DESCRIPTION OF THE PREFERRED EMBODIMENTS

Some modes of carrying out the invention are described below with reference to the accompanied drawings.

### A. First Embodiment

### (A1) Configuration of Video Imaging System

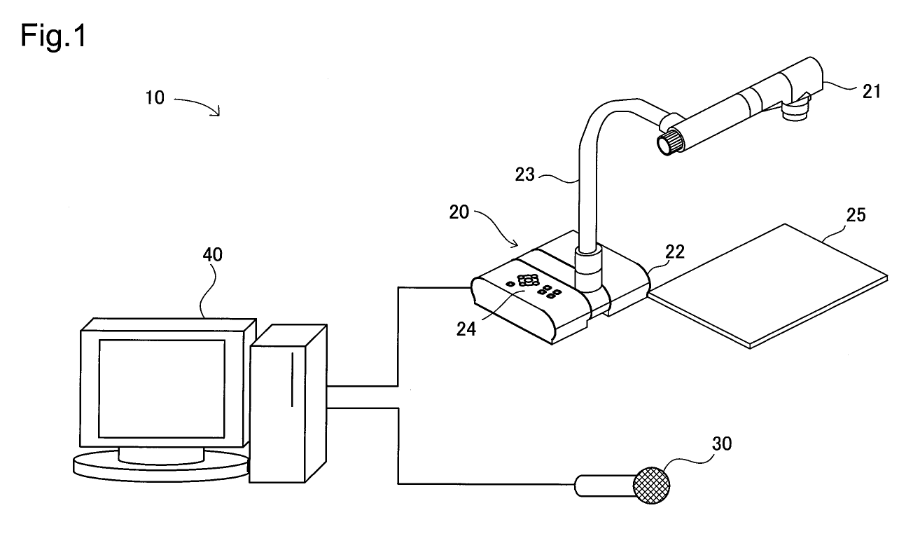

FIG. 1 is a configuration diagrammatic representation of a video imaging system 10 according to one embodiment of the invention. The video imaging system 10 includes a visual presenter 20, a microphone 30, and a computer 40. The visual presenter 20 is externally connected with the computer 40 by USB (universal serial bus) connection. The microphone 30 is connected with the computer 40 by means an audio cable. The voice and sound collected by the microphone is input as analog signals into the computer 40 via the audio cable.

The description of this embodiment is on the assumption that the user makes a presentation with various materials and records the presentation as video data. The visual presenter 20 is used to take a moving image of each material presented by the user in the presentation. The microphone 30 is used to collect the voice of the user's speech in the presentation. The computer 40 works to generate video data of the presentation, based on the moving image taken by the visual presenter 20 and the voice collected by the microphone 30.

### (A2) Structure of Visual Presenter 20

The external structure of the visual presenter 20 is described with reference to FIG. 1. The visual presenter 20 includes an operation body 22 placed on a desk or another flat surface, a curved support column 23 extended upward from the operation body 22, a camera head 21 fastened to an upper end of the support column 23, and a material table 25 which each material as an imaging object of the visual presenter 20 is placed on. An operation panel 24 is provided on a top face of the operation body 22. The operation panel 24 has a power switch, operation buttons for image correction, buttons for setting and changing a video output destination, and buttons for adjusting the brightness of a camera image. A DC power terminal (not shown) and a USB interface (USB/IF) 260 for the USB connection are provided on a rear face of the operation body 22.

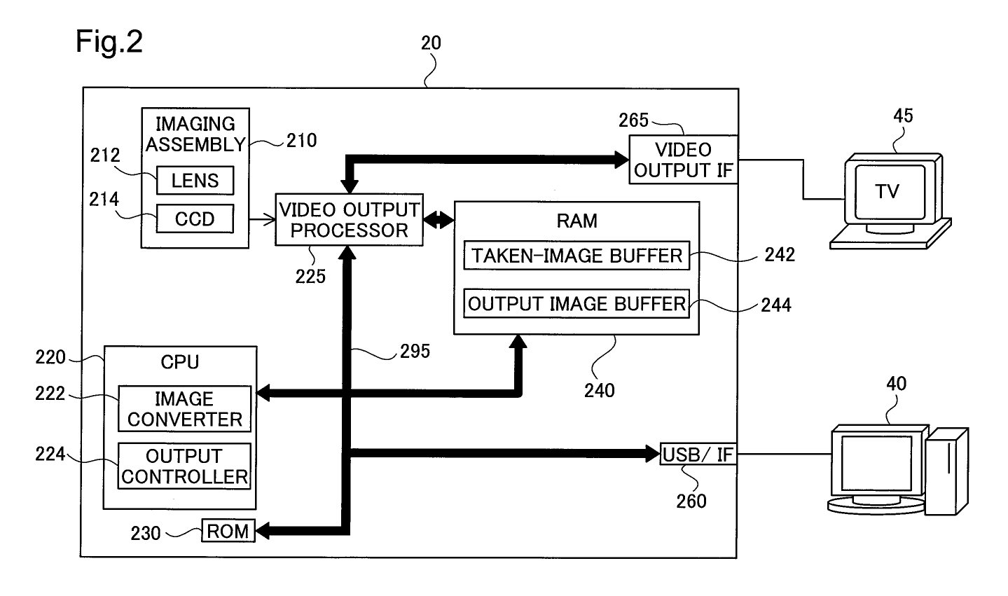

The internal structure of the visual presenter 20 is described. FIG. 2 is an explanatory diagrammatic representation of the internal structure of the visual presenter 20. The visual presenter 20 includes an imaging assembly 210, a CPU 220, a video output processor 225, a ROM 230, a RAM 240, the USB/IF 260, and a video output interface (video output IF) 265, which are interconnected by means of an internal bus 295. The imaging assembly 210 has a lens 212 and a charged coupled device (CCD) 214 and is used to take an image of each material mounted on the material table 25 (FIG. 1).

The video output processor 225 includes an interpolation circuit configured to interpolate a missing color component value in a pixel of image data taken by the imaging assembly 210 from color component values in peripheral pixels, a white balance circuit configured to make white balance adjustment for enabling white parts of a material to be reproduced in white color, a gamma correction circuit configured to adjust the gamma characteristic of image data and thereby enhance the contrast, a color conversion circuit configured to correct the hue, and an edge enhancement circuit configured to enhance the contour. These circuits are not specifically illustrated. Each image data is subjected to a series of processing by these circuits and is stored as taken-image data in a taken-image buffer 242 provided in the RAM 240. The video output processor 225 sequentially outputs the taken-image data stored in the taken-image buffer 242 in the form of video signals expressed in an RGB color space to a television (TV) 45 connecting with the video output IF 265. The series of processing performed by the video output processor 225 in this embodiment may be performed by an image processing-specific digital signal processor (DSP).

The RAM 240 has the taken-image buffer 242 and an output image buffer 244. The taken-image buffer 242 stores the taken-image data generated by the video output processor 225 as explained above. The output image buffer 244 stores frame image data generated as output data to be output to the computer 40 by conversion of the taken-image data by the CPU 220. The details of such data generation will be described later.

The CPU 220 has an image converter 222 and an output controller 224. The image converter 222 converts the taken-image data stored in the taken-image buffer 242 into frame image data as mentioned above. The output controller 224 functions to output the frame image data stored in the output image buffer 244 to the computer 40 connected with the visual presenter 20 via the USB/IF 260. The CPU 220 loads and executes programs stored in the ROM 230 to implement these functional blocks.

### (A3) Structure of Computer 40

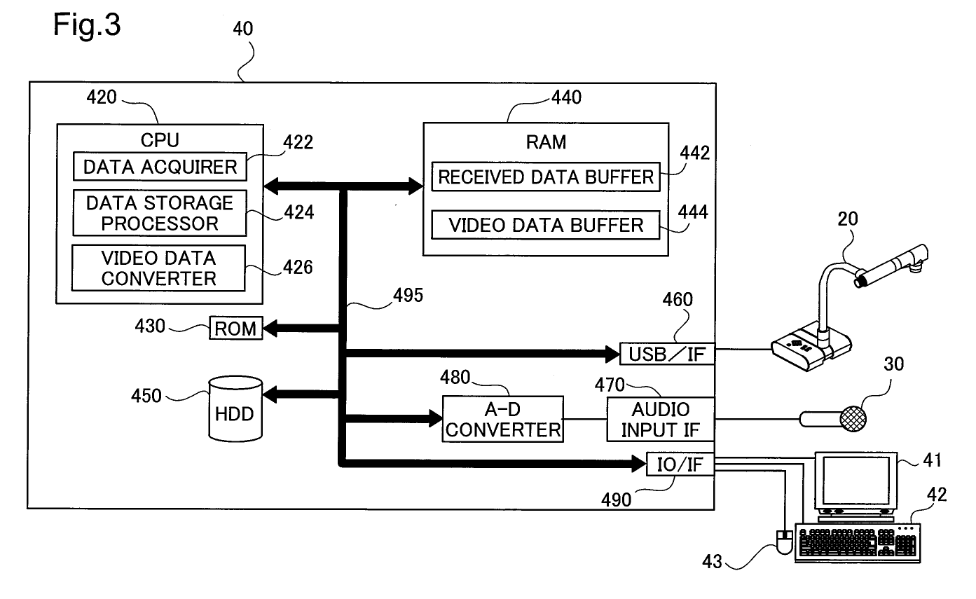

The structure of the computer 40 is described. FIG. 3 is an explanatory diagrammatic representation of the structure of the computer 40. The computer 40 has a CPU 420, a ROM 430, a RAM 440, and a hard disk (HDD) 450, which are interconnected by means of an internal bus 495. The computer 40 also includes a USB/IF 460 connected with the visual presenter 20, an audio input interface (audio input IF) 470 connected with the microphone 30 to input an analog audio signal, an A-D converter 480 configured to convert the input analog audio signal into digital audio data, and an input-output interface (IO/IF) 490. A display 41, a keyboard 42, and a mouse 43 are connected to the IO/IF 490.

The CPU 420 has a data acquirer 422 configured to obtain frame video data and audio data respectively from the visual presenter 20 and via the microphone 30, a data storage processor 424 configured to store the obtained data into the RAM 440 according to a predetermined rule, and a video data converter 426 configured to generate video data from the frame image data and the audio data stored in the RAM 440. The CPU 420 loads and executes a visual presenter-specific video recording application program (hereafter may be simplified as ‘video recording program’) stored in the ROM 430 to implement these functional blocks.

The RAM 440 has a received data buffer 442 and a video data buffer 444. The received data buffer 442 stores the frame image data and the audio data respectively obtained from the visual presenter 20 and via the microphone 30 as mentioned above. The video data buffer 444 stores the video data generated from the frame image data and the audio data by the CPU 420.

### (A4) Video Data Generation Process

Series of video data generation process performed by the video imaging system 10 are described. The series of video data generation process include an image output process performed by the visual presenter 20 and a data acquisition process, a data storage process, and a video data conversion process performed by the computer 40. The image output process performed by the visual presenter 20 is explained first. After the power supply of the visual presenter 20 (FIG. 2), the imaging assembly 210 continually takes a moving image of the materials mounted on the material table 25 at an imaging speed of 15 frames per second. The video output processor 225 generates taken-image data and stores the generated taken-image data into the taken-image buffer 242. On connection of a video display apparatus such as a television or a projector (the television 45 in this embodiment) with the video output IF 265, the video output processor 225 reads out the taken-image data stored in the taken-image buffer 242 and outputs the read-out taken-image data as RGB video signals to the video display apparatus.

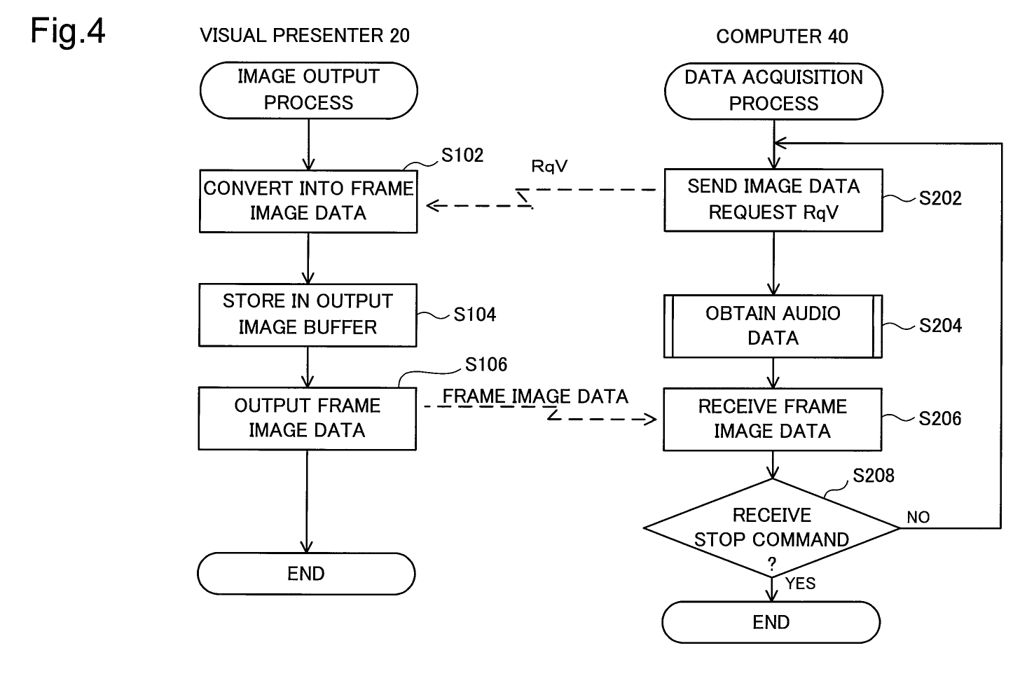

Reception of an image data request RqV from the computer 40 by the visual presenter 20, which is in the state of continually generating taken-image data and storing the taken-image data into the taken-image buffer 242, triggers the image output process. FIG. 4 is flowcharts showing the image output process performed by the visual presenter 20, as well as the data acquisition process performed by the computer 40. When the visual presenter 20 receives an image data request RqV from the computer 40, the CPU 220 of the visual presenter 20 (FIG. 2) reads out one frame of taken-image data generated immediately after the reception of the image data request RqV from the taken-image buffer 242 and performs data compression to convert the read-out taken-image data into frame image data that is to be output to the computer 40 (step S102). The frame image data may be in any adequate data format, such as JPG (Joint Photographic Experts Group: JPEG), BMP (bitmap), or GIF (Graphics Interchange Format). In this embodiment, the CPU 220 converts the taken-image data into frame image data in the JPG format.

After conversion of the taken-image data into the frame image data, the CPU 220 stores the frame image data into the output image buffer 244 (step S104). Subsequently the CPU 220 outputs the frame image data stored in the output image buffer 244 to the computer 40 via the USB/IF 260 (step S106). The image output process by the visual presenter 20 is then terminated. The image output process is performed repeatedly by the CPU 220 every time an image data request RqV is received from the computer 40. The image output process is terminated on reception of the user's recording stop command via the video recording program.

An image output time is described here. The image output time represents a time period when the CPU 220 receives an image data request RqV, performs the processing of steps S102 to S106, and outputs frame image data to the computer 40. On reception of an image data request RqV from the computer 40, the CPU 220 starts data compression of the taken-image data to be converted into frame image data in the JPG format and outputs the frame image data. The image output time accordingly depends on a required time for compression of the taken-image data by the CPU 220. The required time for compression of the taken-image data differs according to the contents of the taken-image data. The image output time is thus not constant but is varied, so that the computer 40 receives frame image data at irregular intervals.

The data acquisition process performed by the CPU 420 of the computer 40 is described below with reference to the flowchart of FIG. 4. Reception of the user's recording start command by the CPU 420 via the video recording program stored in the computer 40 triggers the data acquisition process. On the start of the data acquisition process, the CPU 420 sends an image data request RqV to the visual presenter 20 to obtain frame image data from the visual presenter 20 (step S202). The CPU 420 subsequently obtains audio data, which is collected by the microphone 30 and is converted into digital data by the A-D converter 480, in a PCM (pulse code modulation) data format via an OS (operating system) implemented on the computer 40 (step S204). More specifically, the CPU 420 obtains the audio data in a data length unit of 100 msec at fixed intervals. The CPU 420 of this embodiment obtains the audio data in the data length unit of 100 msec in the PCM data format. This is, however, not restrictive but is only illustrative. The audio data may be in any other suitable data format, such as MP3, WAV, or WMA. The data length unit is not restricted to 100 msec but may be set arbitrarily within a processible range by the CPU 420. The computer 40 receives one frame of frame image data output from the visual presenter 20 (step S206). The processing of steps S202 to S206 is repeatedly performed until the CPU 420 receives the user's recording stop command via the video recording program stored in the computer 40 (step S208). For the convenience of explanation, in the data acquisition process of FIG. 4, the reception of frame image data at step S206 is shown as the subsequent step to the acquisition of audio data at step S204. This is explained more in detail.

In a time period between transmission of an image data request RqV and reception of one frame of frame image data from the visual presenter 20, the CPU 420 continually obtains audio data in the data length unit of 100 msec at fixed intervals. This means that more than one audio data in the data length unit of 100 msec may be obtained in this time period. For example, when the time period between a start of acquisition of audio data triggered by transmission an image data request RqV and reception of frame image data is 300 msec, the CPU 420 has obtained three audio data in the data length unit of 100 msec, i.e., audio data having the total data length of 300 msec. When the time period between a start of acquisition of audio data and reception of frame image data is less than 100 msec, the CPU 420 has not obtained any audio data but terminates the data acquisition process on reception of frame image data. In the actual procedure, the reception of frame image data at step S206 is not simply subsequent to the acquisition of audio data at step S204. The reception of frame image data at step S206 and the acquisition of audio data at step S206 actually form a subroutine, where the reception of frame image data stops further acquisition of audio data.

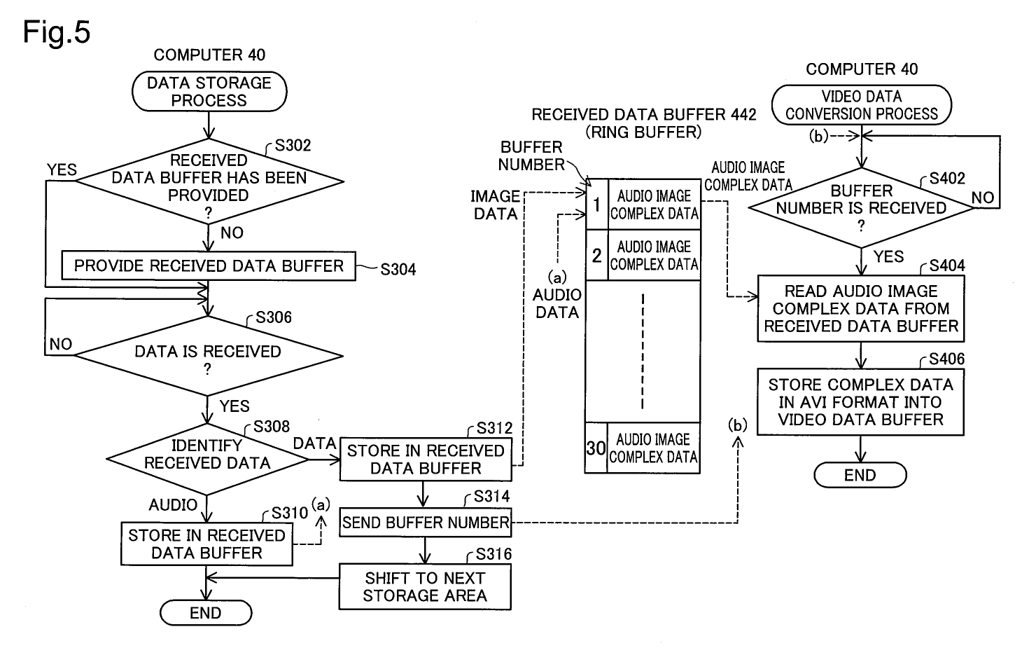

The data storage process and the video data conversion process performed by the computer 40 are described below. FIG. 5 is flowcharts showing the data storage process and the video data conversion process performed by the computer 40. When obtaining the frame image data and the audio data in the data acquisition process (FIG. 4), the CPU 420 stores the obtained frame image data and audio data into the received data buffer 442 in the data storage process. The data storage process performed by the CPU 420 of the computer 40 is described with reference to the flowchart of FIG. 5. Like the data acquisition process, reception of the user's recording start command by the CPU 420 via the video recording program stored in the computer 40 triggers the data storage process.

On the start of the data storage process, the CPU 420 determines whether the received data buffer 442 for storing the obtained frame image data and audio data has already been provided on the RAM 440 (step S302). When the received data buffer 442 has not yet been provided (step S302: No), the CPU 420 provides the received data buffer 442 on the RAM 440 (step S304).

The received data buffer 442 has thirty storage areas as shown in FIG. 5. Each of the thirty storage areas has a storage capacity of storing one frame of frame image data and 10 seconds of audio data. The received data buffer 442 functions as a ring buffer. Data are sequentially stored in an ascending order of buffer numbers 1 to 30 allocated to the respective storage areas in the received data buffer 442. After occupation of the storage area of the buffer number 30, subsequent data storage overwrites the previous data stored in the storage area of the buffer number 1. The received data buffer 442 of the embodiment is equivalent to the storage in the claims of the invention.

After provision of the received data buffer 442, the CPU 420 waits for reception of frame image data from the visual presenter 20 or audio data via the microphone 30 (step S306). When receiving either frame image data or audio data in the data acquisition process described above with reference to FIG. 4, the CPU 420 identifies whether the received data is frame image data or audio data (step S308). When the received data is identified as audio data at step S308, the CPU 420 stores the received audio data into a current target storage area in the received data buffer 442 (ring buffer) (step S310). In a first cycle of the data storage process, the CPU 420 stores first-received audio data into the storage area of the buffer number 1 as a current target storage area in the received data buffer 442 and terminates the data storage process. The end of one cycle of the data storage process immediately starts a next cycle of the data storage process. The data storage process is repeatedly performed and is terminated on reception of the user's recording stop command via the video recording program.

In the repeated cycles of the processing, when the received data is identified as one frame of frame image data at step S308, the CPU 420 stores the received frame image data into the current target storage area in the received data buffer 442 (step S312). For example, when one frame of frame image data is obtained for the first time in the repeated cycles of the data storage process, the CPU 420 stores the received frame image data into the storage area of the buffer number 1 as the current target storage area. When the audio data have already been stored in the storage area of the buffer number 1, the frame image data is additionally stored into the storage area of the buffer number 1 to be combined with the stored audio data.

After storage of the frame image data into the received data buffer 442 at step S312, the CPU 420 sends the buffer number of the current target storage area, which the frame image data is stored in, in the form of a command or a message to the video data conversion process described later (step S314). The CPU 420 subsequently shifts the target storage area for storage of received data to a next storage area (step S316). For example, when audio data is stored in the storage area of the buffer number 1 in a first cycle of the data storage process and when one frame of frame image data is additionally stored into the storage area of the buffer number 1 to be combined with the stored audio data in a subsequent cycle of the data storage process, the CPU 420 shifts the target storage area for storage of subsequently received data to the storage area of the buffer number 2.

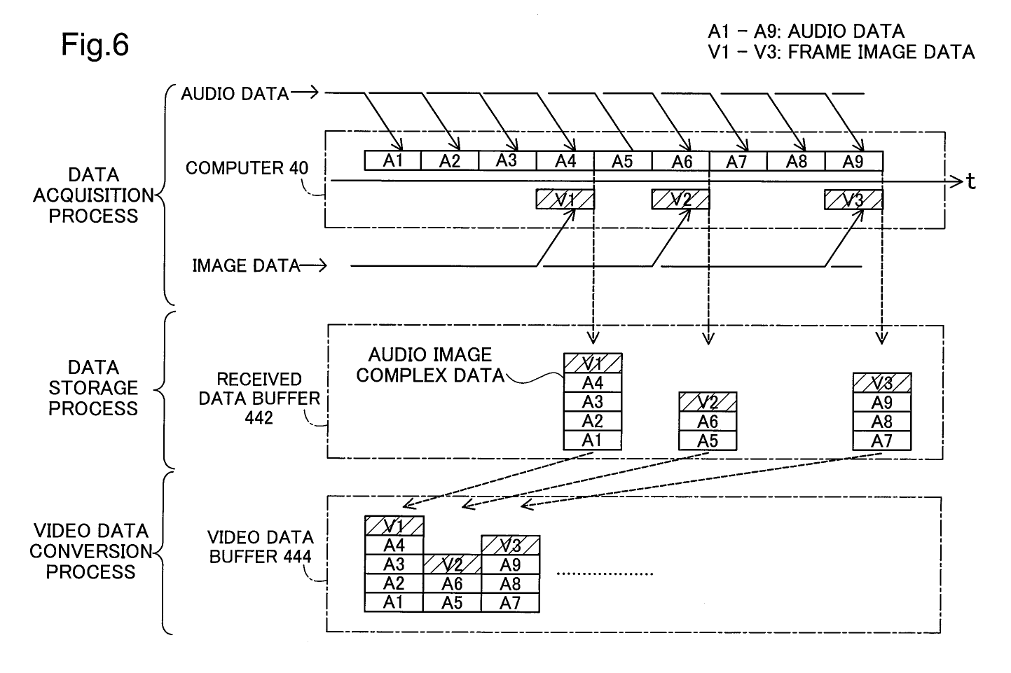

The respective processes performed by the computer 40 are explained more in detail. FIG. 6 is an explanatory diagrammatic representation of the concept of the data acquisition process, the data storage process, and the video data conversion process (described later) performed by the computer 40. An upper section of FIG. 6 shows a state where the computer 40 receives audio data A1 through A9 in the data length unit of 100 msec at fixed intervals, while receiving frame image data V1 through V3 of every one frame at irregular intervals. In the diagram of FIG. 6, each of V1, V2, and V3 represents one frame of frame image data.

As described above, audio data in the data length unit of 100 msec received by the computer 40 are sequentially stored in the receiving order into a current target storage area in the received data buffer 442. When one frame of frame image data is input, the frame image data is additionally stored in the current target storage area to be combined with the stored audio data. Subsequently received audio data are then sequentially stored in the receiving order into a next target storage area. When another one frame of frame image data is input, the frame image data is additionally stored in the next target storage area to be combined with the stored audio data. In the illustrated example of FIG. 6, the computer 40 sequentially receives audio data A1 through A9 at fixed intervals. In the course of such audio data reception, when one frame of frame image data V1 is input into the computer 40, the input frame image data V1 is additionally stored in the storage area of the buffer number 1 as a current target storage area to be combined with audio data A1 through A4 received before the input of the frame image data V1 and integrally form one audio image complex data. Audio data subsequently received after the input of the frame image data V1 are sequentially stored in the receiving order into the storage area of the buffer number 2 as a next target storage area. When another one frame of frame image data V2 is input, the input frame image data V2 is additionally stored in the storage area of the buffer number 2 to be combined with audio data A5 and A6 received before the input of the frame image data V2 and integrally form one audio image complex data.

A lower section of FIG. 6 shows a state where the video data converter function of the CPU 420 reads out audio image complex data in the storage order from the respective storage areas in the received data buffer 442 and stores the read audio image complex data in an AVI (audio video interleave) data format in the video data buffer 444 to generate video data. This series of processing is described below as the video data conversion process with reference to the flowchart of FIG. 5. The CPU 420 generates video data from the audio data and the frame image data according to this series of processing.

Referring back to the flowchart of FIG. 5, the video data conversion process performed by the CPU 420 of the computer 40 is described. Like the data acquisition process and the data storage process, reception of the user's recording start command by the CPU 420 via the video recording program stored in the computer 40 triggers the video data conversion process. Namely the CPU 420 establishes and executes three processing threads of the data acquisition process, the data storage process, and the video data conversion process, on reception of the user's recording start command.

On the start of the video data conversion process, in response to reception of the buffer number (step S402), which is sent at step S314 in the data storage process, the CPU 420 reads out audio image complex data from a storage area in the received data buffer 442 specified by the received buffer number (step S404) and stores the read audio image complex data in the AVI data format into the video data buffer 444 (step S406). The video data conversion process is then terminated. The video data conversion process is repeatedly performed at preset intervals and is terminated on reception of the user's recording stop command by the CPU 420 via the video recording program stored in the computer 40.

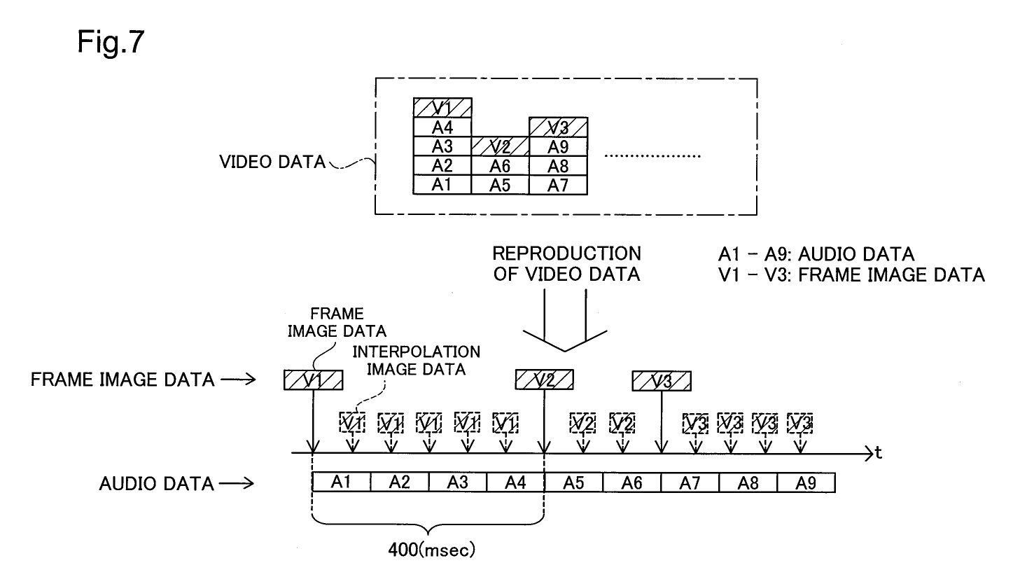

Reproduction of video data generated by the video imaging system 10 is described. FIG. 7 is an explanatory diagrammatic representation of the concept of reproduction of generated video data by the computer 40. In the video data reproduction process, the CPU 420 reads video data stored in the AVI data format and reproduces the multiple audio image complex data included in the read video data in time series in the units of the audio image complex data. The audio data are sequentially reproduced in the storage order from the audio data A1 at a fixed reproduction speed. The frame image data is reproduced simultaneously with reproduction of the first audio data included in the same audio image complex data. In the illustrated example of FIG. 7, the frame image data V1 is reproduced simultaneously with reproduction of the first audio data A1 included in the same audio image complex data.

In the course of reproduction of audio data and frame image data in this manner, however, there may be a longer interval between two adjacent frame image data. The longer interval causes some awkwardness and unnaturalness in a reproduced moving image. When a reproduction interval of two adjacent frame image data is longer than a preset time interval, an interpolation image is accordingly generated and reproduced between two adjacent frame image data, so as to interpolate the longer interval. The frame image data immediately before the longer interval requiring the interpolation may be used as the interpolation image.

In this embodiment, a moving image is displayed by reproducing frame image data of video image at a frame rate of 15 frames per second. The reproduction interval of frame image data is thus about 67 msec. When the reproduction interval of two adjacent frame image data is longer than this reproduction interval of 67 msec, an interpolation image is generated and reproduced to interpolate the longer interval. In the illustrated example of FIG. 7, the reproduction interval between the two frame image data V1 and V2 is 400 msec. Five interpolation images as duplicates of the frame image data V1 are thus generated and reproduced in the reproduction interval between the two frame image data V1 and V2. Such interpolation enables the reproduction interval of the frame image data with the interpolation images to be about 67 msec, thus assuring the smooth and natural movement of the reproduced moving image. This embodiment adopts the frame rate of 15 frames per second for reproduction of the moving image. For the smoother movement of the reproduced moving image, the frame rate may be increased to be higher than 15 frames per second, for example, 30 or more frames per second. The lower frame rate of 15 or 20 frames per second decreases the required number of interpolation images generated and reproduced, thus relieving the processing load of the CPU 420.

As described above, in the video data generation process performed in the video imaging system 10, the computer 40 obtains audio data via the microphone 30 at fixed intervals and frame image data from the visual presenter 20 at irregular intervals. A group of audio data obtained before input of one frame of frame image data is combined with the input frame image data to form one audio image complex data and to be registered in each storage area of the received data buffer 442. Multiple audio image complex data are collectively stored as one set of generated video data. This arrangement allows for reproduction of generated video data without causing asynchronism or a time lag between sound reproduction based on audio data and image reproduction based on frame image data included in the same video data.

### B. Other Aspects

### (B1) Modification 1

The embodiment described above generates video data from the audio data obtained via the microphone 30. One modification may directly obtain digital audio data from an acoustic output apparatus, such as a CD player, an electronic piano, an electronic organ, or an electronic guitar and generate video data from the obtained digital audio data. In one application of this modification, the visual presenter 20 is placed at a position suitable for taking images of a keyboard of an electronic piano. The computer 40 obtains image data from the visual presenter 20, which takes images of the finger motions of a piano player who plays the electronic piano. Simultaneously the computer 40 obtains the sound of the piano player's performance as digital audio data directly from a digital sound output of the electronic piano. The computer 40 generates video data from the obtained image data and the obtained digital audio data. This modification assures the similar effects to those of the embodiment described above and allows for reproduction of video data for a piano lesson without causing asynchronism or a time lag between sound reproduction and image reproduction.

The embodiment and its modified example discussed above are to be considered in all aspects as illustrative and not restrictive. There may be many other modifications, changes, and alterations without departing from the scope or spirit of the main characteristics of the present invention. In the embodiment described above, the frame image data is generated by and obtained from the visual presenter 20. The frame image data may be generated by and obtained from another suitable imaging apparatus, such as a digital camera or a web camera. Such modification also assures the similar effects to those of the embodiment described above. In the embodiment, the video data are stored in the AVI data format. The video data may be stored in another suitable data format, for example, mpg (mpeg) or rm (real media). The video data once stored in the AVI data format may be converted into the mpg data format or the rm data format according to a conventionally known data conversion program. After storage of multiple audio image complex data, image compression between frame image data included in the multiple audio image complex data may be performed for image conversion into the mpg data format.

All changes within the meaning and range of equivalency of the claims are intended to be embraced therein. The scope and spirit of the present invention are indicated by the appended claims, rather than by the foregoing description.

1. A video data generation apparatus of generating video data based on audio data and frame image data, which are generated independently of each other, the video data generation apparatus comprising:
an audio input configured to sequentially input the audio data at fixed intervals;
an image input configured to sequentially input the frame image data in time series at irregular intervals;
a data acquirer configured to, simultaneously with input of one frame of frame image data, start a data acquisition process to obtain next one frame of frame image data;
a storage configured to store audio data, which have been input in a period between a start of the data acquisition process by the data acquirer and input of one frame of frame image data by the data acquisition process, in combination with the frame image data of one frame obtained by the data acquisition process, as one audio image complex data; and
a video data converter configured to generate the video data based on multiple audio image complex data stored in the storage.

2. The video data generation apparatus in accordance with claim 1, wherein the audio data are input into the video data generation apparatus at shorter cycles than those of the frame image data.

3. The video data generation apparatus in accordance with claim 2, wherein the audio data are input as data in a preset time unit.

4. The video data generation apparatus in accordance with claim 1, wherein the audio data are generated based on voice and sound collected via a microphone and are input into the video data generation apparatus.

5. The video data generation apparatus in accordance with claim 1, wherein the audio data are generated based on sound output from an audio output apparatus having a sound source and are input into the video data generation apparatus.

6. The video data generation apparatus in accordance with claim 1, wherein the frame image data are input into the video data generation apparatus from one of a visual presenter, a digital camera, and a web camera.

7. The video data generation apparatus in accordance with claim 1, wherein the frame image data are input in a data format selected among the group consisting of a JPG or JPEG data format, a BMP or Bitmap data format, and a GIF data format.

8. The video data generation apparatus in accordance with claim 1, wherein the video data are generated in an AVI or audio video interleave data format.

9. A video data generation system including a video data generation apparatus, a visual presenter, and a microphone,
the video data generation apparatus comprising:
an audio input configured to sequentially input the audio data via the microphone at fixed intervals;
an image input configured to sequentially input the frame image data from the visual presenter in time series at irregular intervals;
a data acquirer configured to, simultaneously with input of one frame of frame image data, start a data acquisition process to obtain next one frame of frame image data;
a storage configured to store audio data, which have been input in a period between a start of the data acquisition process by the data acquirer and input of one frame of frame image data by the data acquisition process, in combination with the frame image data of one frame obtained by the data acquisition process, as one audio image complex data; and
a video data converter configured to generate the video data based on multiple audio image complex data stored in the storage.

10. A video data generation method of generating video data based on audio data and frame image data, which are generated independently of each other, the video data generation method comprising:
sequentially inputting the audio data at fixed intervals;
sequentially inputting the frame image data in time series at irregular intervals;
simultaneously with input of one frame of frame image data, starting a data acquisition process to obtain next one frame of frame image data;
storing audio data, which have been input in a period between a start of the data acquisition process by the data acquirer and input of one frame of frame image data by the data acquisition process, in combination with the frame image data of one frame obtained by the data acquisition process, as one audio image complex data; and
generating the video data based on multiple stored audio image complex data.

11. A computer program product including a computer program of causing a computer to generate video data based on audio data and frame image data, which are generated independently of each other, the computer program recorded on a recordable medium and causing the computer to attain the functions of:
sequentially inputting the audio data at fixed intervals;
sequentially inputting the frame image data in time series at irregular intervals;
simultaneously with input of one frame of frame image data, starting a data acquisition process to obtain next one frame of frame image data;
storing audio data, which have been input in a period between a start of the data acquisition process by the data acquirer and input of one frame of frame image data by the data acquisition process, in combination with the frame image data of one frame obtained by the data acquisition process, as one audio image complex data; and
generating the video data based on multiple stored audio image complex data.
